(19) United States
(12) Patent Application Publication
(10) Pub. No.: US 2015/0041167 A1
(43) Pub. Date: Feb. 12, 2015

(54) ELECTRIC WORKING MACHINE

(71) Applicant: HITACHI KOKI CO., LTD., Tokyo (JP)

(72) Inventors: Hayato Yamaguchi, Ibaraki (JP); Hideyuki Tanimoto, Ibaraki (JP)

(21) Appl. No.: 14/379,298

(22) PCT Filed: Mar. 27, 2013
(86) PCT No.: PCT/JP2013/060143

§ 371 Date: Aug. 17, 2014

(30) Foreign Application Priority Data
Mar. 30, 2012 (JP) 2012-078778

(51) Int. Cl. H02K 7/14; H02K 9/06; B25F 5/00

(52) U.S. Cl. CPC H02K 7/145; B25F 5/008; H02K 9/06
USPC 173/46; 173/217

(57) ABSTRACT

To provide an electric working machine, in which a brushless motor is mounted, in order to improve energy efficiency. An electric working machine includes: a disk motor including a rotor having a permanent magnet pole, an output shaft fixed to the rotor and serving as a rotation center of the rotor and a stator configured to generate a magnetic field with respect to the rotor; and a housing configured to accommodate the rotor therein and to rotatably support the output shaft. The stator includes: a magnetic yoke facing the rotor; and a coil board provided on a surface of the yoke facing the rotor. The stator is fixed to the housing side. The coil board has an extension portion on an outer circumferential edge thereof. Electric circuit elements for a motor driving circuit are mounted on the extension portion.

### TECHNICAL FIELD

The present invention relates to an electric working machine, such as an electric bush cutter or an electric pruning machine, in which a brushless disk motor is mounted.

### BACKGROUND ART

In general, a brush motor is used as a driving source for an electric bush cutter used for cutting grass or an electric pruning machine used for trimming hedges or plants and the like. For the electric bush cutter, there have been proposed to use a small flat disk motor.

Such a disk motor includes a rotor coil board having a coil pattern printed thereon and a rotation shaft for holding the rotor coil board, and is configured to output a rotational force by a magnetic field applied to the rotor coil board. The disk motor has light weight, low noise, low vibration, and high efficiency, compared with a motor in which a magnetic core having a copper wire wounded thereon is made as a rotor.

The rotation shaft has a flange portion that is integrated with the rotation shaft. The rotor coil board is fixed such that that it is coaxial with the rotation shaft and it contacts the flange. A commutator substrate for supplying an electric current to the rotor coil board is installed on a surface of the flange which does not contact the rotor coil board.

PTL 1 as described below discloses a configuration example of an electric bush cutter, in which a disk motor having a commutator attached thereon is used.

### CITATION LIST

### Patent Literature

PTL 1: JP-A-2011-92178

### SUMMARY OF INVENTION

### Technical Problem

In a structure of the related-art disk motor, an electric current is supplied to a rotor coil board by a commutator substrate provided on a rotor and a brush provided on a housing for containing the motor, thereby obtaining a rotational force. There is a problem in that a friction loss is occurred by sliding between the commutator substrate and the brush, and thus energy is wasted. In such a related-art disk motor, the maximum energy efficiency is approximately 65%, and for example, the input electric power is 200 W, the output power is 130 W, and the rotation number is 4,000 rpm. To produce various products in which a disk motor is used, it is necessary to further increase output power thereof.

However, if the input electric power is increased to increase the output power, an amount of heat generation may be also increased, thereby causing burning of the disk motor. The related-art disk motor may be burned when the rotation number is 10,000 rpm. Therefore, to obtain a higher output power by a lower input electric power, an improvement of energy efficiency is required.

### Solution to Problem

Accordingly, one illustrative aspect of the present invention provides an electric working machine having a brushless disk motor, which can improve an energy efficiency of the disk motor by a simple structure.

Another illustrative aspect of the invention provides an electric working machine, in which cooling of a brushless disk motor and a driving circuit associated therewith can be effectively performed.

According to a first illustrative aspect of the invention, there is provided an electric working machine comprising: a housing having a motor; a working unit provided to the housing and is configured to be driven by the motor; and a gripping section provided to be extended from the housing. The motor is a disk motor, the disk motor comprising: a rotor having a substantially circular disk shape and comprising a plurality of permanent magnet poles; an output shaft coaxially fixed to the rotor and serving as a rotation center of the rotor; and a stator having a coil board and generating a magnetic field with respect to the rotor. An electric circuit element for a motor driving circuit is mounted on the housing at a side of the gripping section.

According to a second illustrative aspect of the invention, there is provided an electric working machine comprising: a disk motor comprising: a rotor having a substantially circular disk shape and comprising a plurality of permanent magnet poles; an output shaft coaxially fixed to the rotor and serving as a rotation center of the rotor; and a stator configured to generate a magnetic field with respect to the rotor; a housing configured to accommodate the rotor and to rotatably support the output shaft; a fan configured to be rotatably driven by the disk motor; and a circuit board having an electric circuit element for a motor driving circuit mounted thereon. The fan is configured to generate air flow by being rotated so as to cool the electric circuit elements for the motor driving circuit.

Incidentally, any combinations of components as described above and conversions between a method and a system and the like in the expression of the present invention are effective as aspects of the present invention.

### Advantageous Effects of Invention

According to the illustrative aspects of the present invention, by modifying a related-art disk motor into a brushless structure, it is possible to achieve an electric bush cutter having a disk motor and can improve energy efficiency.

Further, by adopting a configuration in which a fan is configured to generate air flow by being driven by the disk motor, it is possible to achieve a good cooling of electric circuit elements of the motor driving circuit.

### BRIEF DESCRIPTION OF DRAWINGS

FIG. 1 is a perspective view showing an electric bush cutter as an electric working machine according to a first embodiment of the present invention.

FIGS. 2A and 2B are views showing a driving unit, which includes a disk motor, of the electric bush cutter shown in FIG. 1, in which FIG. 2A is a side sectional view, and FIG. 2B is a rear view.

FIG. 3 is a bottom view showing a rotor of the disk motor.

FIG. 4 is a front sectional view showing the rotor.

FIG. 5 is a plan view showing a surface (a side facing the rotor) of a coil board of the disk motor.

FIG. 6 is a bottom view showing a back surface of the coil board.

FIG. 7 is a plan view showing the surface of the coil board, on an extension portion of which electric circuit elements for a motor driving circuit are mounted.

FIG. 8 is a bottom view showing the back surface of the coil board, on the extension portion of which electric circuit elements for a motor driving circuit are mounted.

FIG. 9 is a perspective view showing an example of an electric pruning machine as an electric working machine according to a second embodiment of the present invention.

FIG. 10 is a perspective view showing another example of an electric pruning machine as an electric working machine according to a third embodiment of the present invention.

### DESCRIPTION OF EMBODIMENTS

### First Embodiment

Preferred embodiments of the present invention will be now described with reference to the accompanying drawings. Incidentally, identical or equivalent components, members, steps and the like shown in each of figures are designated by identical reference numerals and accordingly the repeated descriptions thereof will be properly omitted. Further, the embodiments are intended to illustrate, but do not limit, the invention, and thus all features and combinations thereof described in the embodiments are not necessarily essential to the present invention.

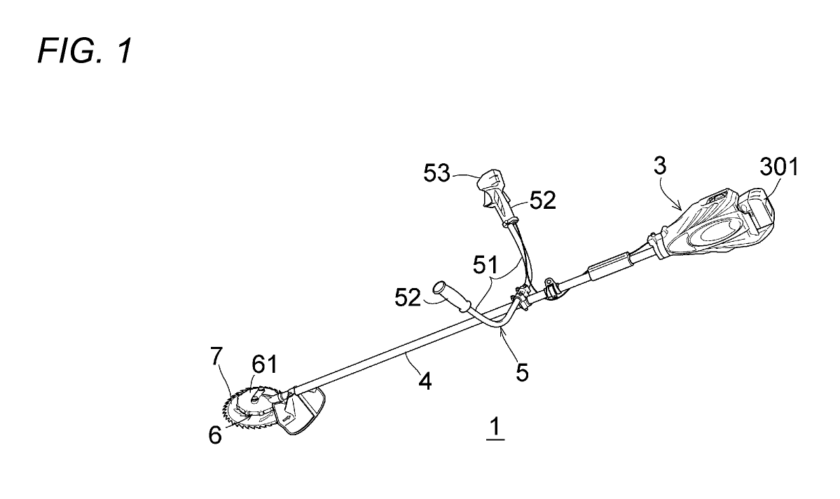

FIG. 1 is a perspective view showing an electric bush cutter 1 as an electric working machine according to a first embodiment of the present invention. The bush cutter 1 as an example of the electric working machine includes a power supply unit 3, a pipe section 4, a handle section 5, a driving unit 6, and a cutting blade 7. A cutting work is performed using the cutting blade 7 serving as a working unit mounted on the driving unit 6.

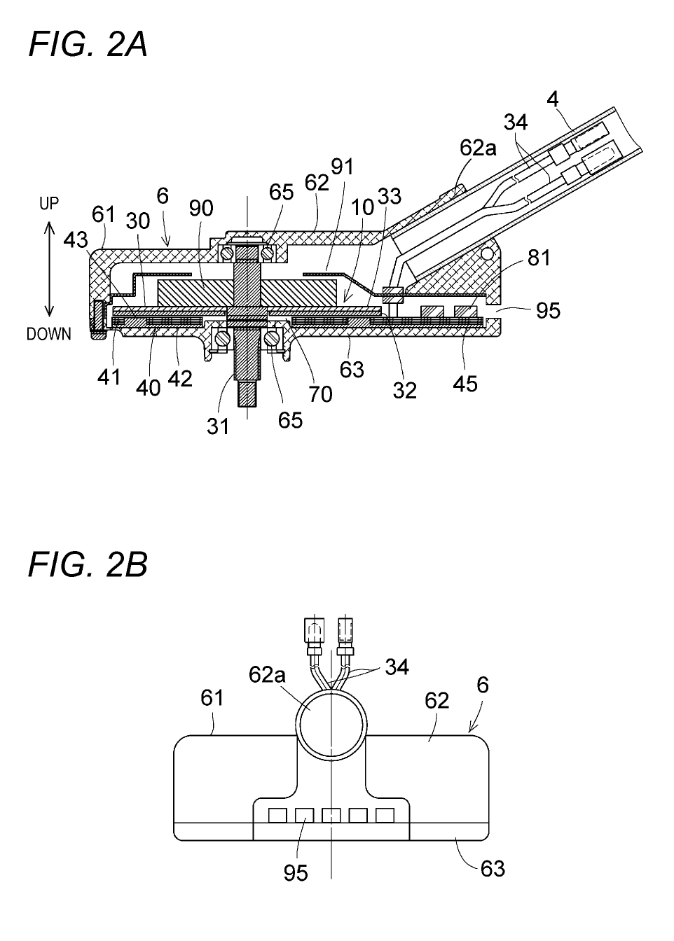

The power supply unit 3 has a battery 301, which is removably mounted thereto, as a power supply. The pipe section 4 mechanically couples (connects) the power supply unit 3 with the driving unit 6. Also, wirings (a power supply cable 34 in FIGS. 2A and 2B and the like) for electrically connecting the power supply unit 3 to the driving unit 6 are inserted through an inside of the pipe section 4. By such wirings, an electric power is supplied from the power supply unit 3 to the driving unit 6. The driving unit 6 includes a brushless disk motor contained inside a head housing 61 and is configured to rotatably drive the cutting blade 7 as a working unit by the electric power supplied from the power supply unit 3. Configurations of the brushless disk motor will be described below.

The handle section 5 is attached and fixed on the middle of the pipe section 4, e.g., between the power supply unit 3 and the driving unit 6. The handle section 5 is configured by a pair of arms 51 each having a grip 52 attached on a distal end thereof. One grip 52 is provided with a throttle 53. The pipe section 4 and the handle section 5 correspond to a gripping section provided to be extended from the head housing 61. A worker can adjust an electric power supplied to the driving unit 6, e.g., a rotation number of the cutting blade 7, by operating the throttle 53. The cutting blade 7 has a generally circular disk shape and includes teeth formed on a circumferential edge thereof. Also, a hole (not shown), which is configured to be mounted to an output shaft of the disk motor (which will be described later) is formed at the center of the cutting blade 7.

FIGS. 2A and 2B are views showing the driving unit 6 of the bush cutter 1 shown in FIG. 1, in which FIG. 2A is a side sectional view taken though the pipe section 4, and FIG. 2B is a rear view as viewed from the pipe section 4. Incidentally, as shown in FIG. 2A, an extension direction of the output shaft 31 is defined as an upward-downward direction. The driving unit 6 includes the brushless disk motor 10 inside the head housing 61. This head housing 61 includes a cover portion 62 and a base portion 63 combined (fitted) with each other and integrated by fixing screws at a plurality of locations and the like.

The brushless disk motor 10 includes a rotor 30, the output shaft 31 and a stator 40. The rotor 30 has a substantially circular disk shape and includes a plurality of permanent magnet poles. The output shaft 31 is coaxially fixed to the rotor 30 and serves as a rotation center of the rotor 30. The stator 40 is configured to generate a magnetic field with respect to the rotor 30. The output shaft 31 is rotatably supported by bearings 65 each provided in the cover portion 62 and the base portion 63.

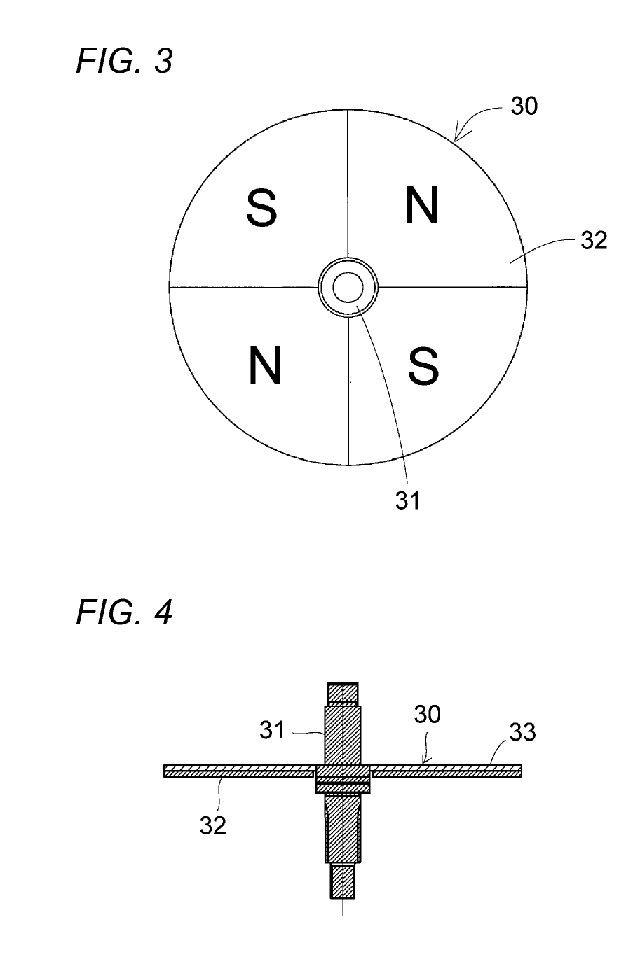

As shown in FIGS. 3 and 4, the rotor 30 includes a flange 33, which is integrally provided on the output shaft 31, and a permanent magnet 32 that is attached and fixed on a bottom surface of the flange 33. The flange 33 is preferably made of a magnetic material, such as iron, because the flange 33 is responsible for a magnetic circuit of the permanent magnet 32. Fixation of the permanent magnet 32 to the flange 33 may be performed by using only a magnetic force or be firmly performed by using an adhesive at an interface between the permanent magnet 32 and the flange 33. The permanent magnet 32 may formed as one sheet of a circular disk shaped magnet magnetized to multipoles, or may formed by concentrically arranging a plurality of circle sector shaped magnets around the output shaft 31. An example shown in FIG. 3 is set such that four poles appear on a lower surface side facing the stator 40.

The stator 40 includes a coil board 41 provided with a stator coil which generates a magnetic field for rotatably driving the rotor 30, an annular yoke 42 made of a soft magnetic material, and magnetic cores 43 integrally formed with the yoke 42.

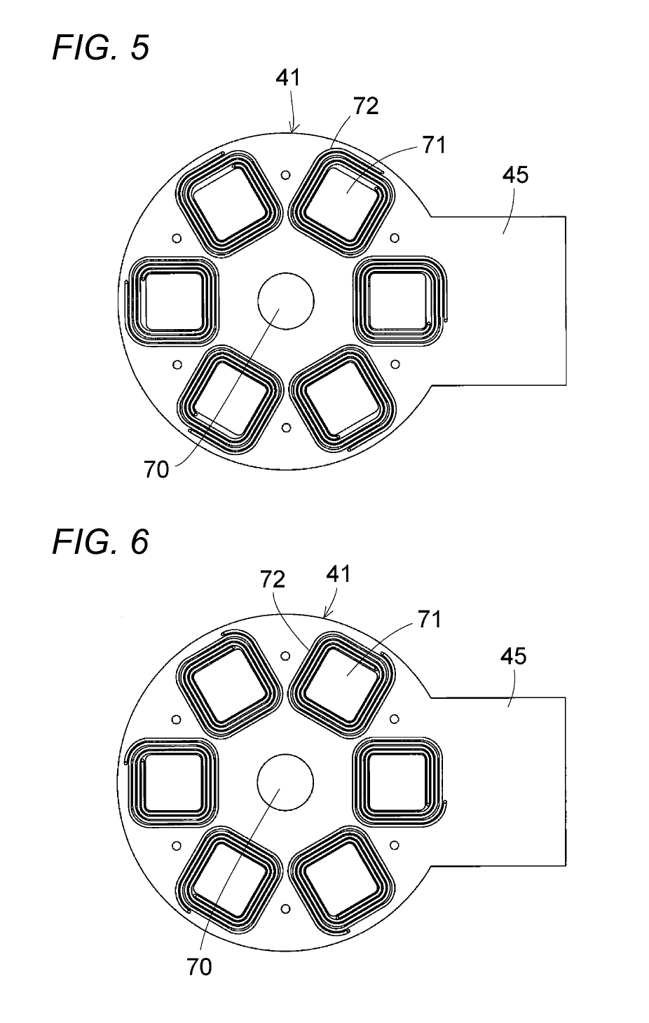

As shown in FIGS. 5 and 6, the coil board 41 includes a central bore 70 configured to allow the output shaft 31 to extend therethrough, perforations 71 formed as through-holes arranged concentrically at equal intervals around the central bore 70, and a conductor coil pattern 72 as a stator coil encircled around each of the perforations 71. The conductor coil patter 72 is formed, for example, by printing.

As shown in FIG. 2A, the annular yoke 42 is fixed on the base portion 63, and the coil board 41 is superimposed and fixed (adhered) on a surface of the annular yoke 42 facing the rotor. In this time, the magnetic cores 43 are inserted into the perforations 71. The magnetic cores 43 form a part of the magnetic circuit including the permanent magnet 32. Such a plurality of magnetic cores 43 are integrally formed with the yoke 42 and arranged concentrically around the output shaft 31. The output shaft 31 is inserted through the central bore 70 of the coil board 41.

Depending on a torque required for the bush cutter 1, the number of the coil patterns 72 per magnetic core can be adjusted, and a plurality of coil boards 41 can be stacked on top of one another. The coil patterns 72 thus stacked can employ a structure in which each of coil patterns 72 is conductively connected to each other by a metal pin (not shown).

FIGS. 5 and 6 respectively show the coil patterns 72 printed on a surface (upper surface) of the coil board 41 and a back surface (lower surface) of the coil board 41. In this case, the coil patterns 72 shown in FIGS. 5 and 6 are oriented in a direction different to each other, because a magnetic force generated from the coil patterns 72 printed on both surfaces of the coil board 41 are configured to be in the same direction. By positioning start ends and terminal ends of the coil patterns 72 printed on both surfaces of the coil board 41 at the same location, the metal pin (not shown) required for conductively connecting each of the coil pattern 72 to each other can be easily installed.

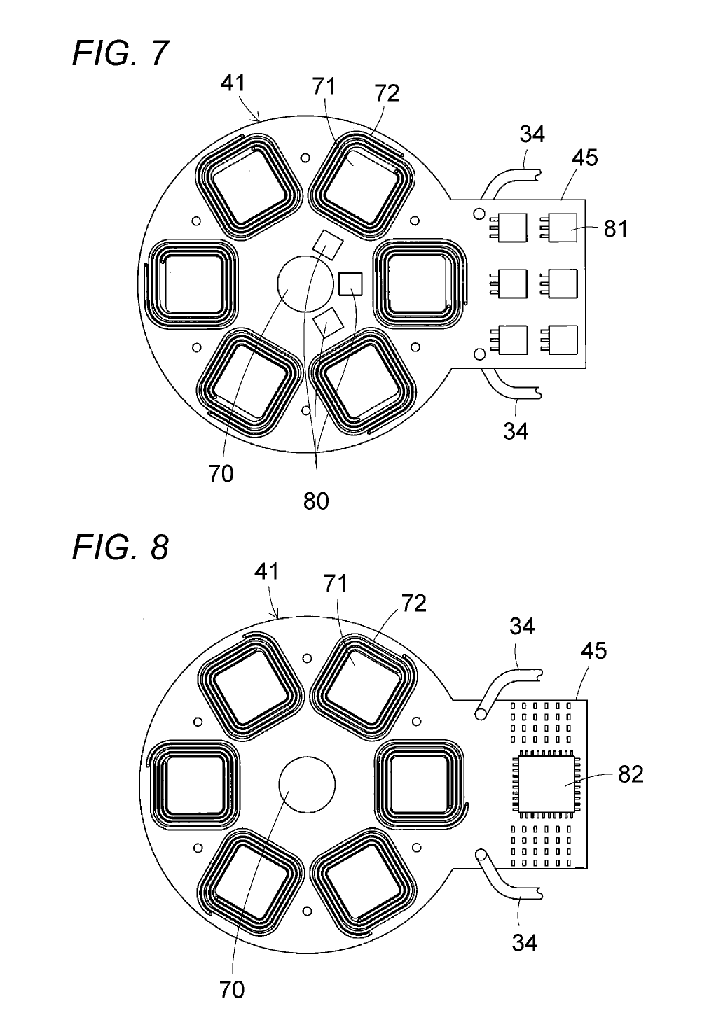

As can be seen from FIGS. 5 and 6, the coil board 41 has a generally square-shaped extension portion 45 (the shape the extension portion 45 may be arbitrary, not limited to the shown shape) on an outer circumferential edge thereof. This extension portion 45 provides a space serving as a circuit board on which electric circuit elements for a motor driving circuit are mounted as shown in FIGS. 7 and 8.

FIG. 7 shows a surface of the coil board 41 facing the rotor 30. A Hall sensor 80 as a rotation state detection unit is provided proximity to the central bore 70 and is configured to detect a rotation angle of the permanent magnet 32 and a position of the rotor 30 to then input the detection results to the motor driving circuit. In this case, the motor driving circuit has an inverter circuit including switching elements, such as FET, and a control circuit (having a microcomputer and the like) configured to generate a control signal for controlling the inverter circuit. Switching elements 81 are surface-mounted on an upper surface of the extension portion 45 extended from a portion of the circumferential edge of the coil board 41. The switching elements 81, such as FET, configure the inverter circuit for switching electrical supply to the coil patterns 72, which form a stator coil. The switching elements 81 and the coil patterns 72 are connected to each other by a pattern (not shown) printed on the back surface of the coil board 41.

FIG. 8 shows a surface of the coil board 41 not facing the rotor 30. Electronic circuit elements 82 are surface-mounted on a lower surface of the extension portion 45. The electronic circuit elements 82 configure, for example, the control circuit generating the control signal for controlling the inverter circuit, and the like. Incidentally, when necessary, the lower surface of the extension portion 45 may be configured to provide a region onto which the yoke 42 does not extend. The power supply cable 34 is connected to the extension portion 45 to supply an electric power to the inverter circuit and the like.

Hereinafter, a mechanism for blowing air to the electric circuit elements mounted on the extension portion 45 and cooling the electric circuit elements will be described with reference to FIGS. 2A and 2B. The output shaft 31 of the brushless disk motor 10 is integrally provided with a centrifugal fan 90. Namely, the centrifugal fan 90 is fixed on the output shaft 31 inside the head housing 61 and provided on an upper side of the rotor 30. Also, a fan guide 91 annularly surrounding upper sides of the rotor 30 and the centrifugal fan 90 is fixed inside the head housing 61. The cover portion 62 of the head housing 61 is provided with a hole 62a configured to insert and fix the pipe section 4 therethrough. The hole 62a also serves as an intake hole (communicated with the outside air through the inside of the pipe section 4). As shown in FIG. 2B, a vent hole 95 is formed between the cover portion 62 and the base portion 63 of the head housing 61.

The head housing 61 has a structure configured to receive the extension portion 45 in the same direction as an extension direction of the pipe section 4. The extension portion 45 is positioned at a location toward the hole 62a of the head housing 61, into which the pipe section 4 is inserted, and also beneath the fan guide 91, namely in an air flow passage for guiding an air flow of the centrifugal fan 90 to the vent hole 95. By positioning the extension portion 45 at such a location, cooling of the electric circuit elements (the switching elements 81 and the like) can be good and also the power supply cable 34 can be minimized in length. Further, the extension portion 45 is positioned such that it is not necessary to provide a protrusion for receiving the extension portion 45 to the head housing 61, and also for a worker, a cutting work is not disturbed and a good workability is obtained.

In the electric bush cutter according to the first embodiment as described above, when an electric power is supplied to the coil patterns 72 of the coil board 41 as a stator coil through a path of from the power supply unit 3 via the power supply cable 34 to the inverter circuit of the motor driving circuit, the rotor 30 is rotated by an electromagnetic force between a magnetic field generated by the coil patterns 72 and the magnetic poles of the permanent magnet 32 of the rotor 30. By detecting the rotation state of the rotor 30 by the Hall sensor 80 and by controlling the inverter circuit by the control circuit, the rotation of the rotor 30 can be continued. When the rotor 30 is rotated, the centrifugal fan 90 integrated with the rotor 30 is also rotated to generate an air flow (e.g., a fan airflow), which flows from the hole 62a serving as an intake hole via an upper opening of the fan guide 91 (e.g., an intake hole in the center portion of the fan guide 91 formed around the output shaft 31) into the centrifugal fan 90 and also is guided toward the vent hole 95. Namely, the fan airflow generated by the fan 90 firstly flows along an axial direction of the rotor 30 and then flows toward the handle (e.g., the pipe section 4) provided in a radial direction. By blowing this fan airflow to switching elements 81 of the inverter circuit and the like, the elements can be effectively cooled. Also, the fan airflow can also cool the permanent magnet 32 of the rotor 30.

Further, when the yoke 42 is in tightly contact with the back surface of the extension portion 45 of the coil board 41 and also with the head housing 61, a heat generated from the coil patterns 72 of the coil board 41 and also the switching elements 81 can be transferred to the housing, thereby dissipating the heat by heat conduction. Incidentally, in such a configuration, when the head housing 61 is made by shaping an aluminum alloy having a good thermal conductivity, the cooling effect can be improved, so that it is possible to suppress the temperature rise of the coil board 41, the switching element 81 and the like.

According to the present embodiment, the following effects can be achieved.

(1) By modifying a typical disk motor into a brushless structure, an electric bush cutter in which a disk motor having an improved energy efficiency is equipped can be achieved.

(2) The centrifugal fan 90 is driven by the disk motor 10 to generate an air flow (e.g., fan airflow) and the switching elements 81, the electronic circuit element 82 and the like of the motor driving circuit are provided on a passage of the air flow, thereby achieving a good cooling thereof. In addition, the permanent magnet 32 of the rotor 30 can be cooled by the air flow, thereby preventing deterioration of the permanent magnet 32 due to thermal demagnetization.

(3) The coil board 41 configuring a stator coil is provided with the extension portion 45, and electric circuit elements for the motor driving circuit are mounted on the extension portion 45 (e.g., the extension portion 45 serves as a circuit board). As a result, an arrangement space for the motor driving circuit can be easily secured and the head housing 61 can be prevented from being enlarged in shape.

(4) The extension portion 45 is positioned at a side where the hole 62a of the head housing 61, into which the pipe section 4 is inserted, is provided. Also, the extension portion 45 is provided beneath the fan guide 91, namely on an air flow passage for guiding a fan airflow flow of the centrifugal fan 90 to the vent hole 95. By positioning the extension portion 45 at such a location, cooling of the electric circuit elements can be good and also the power supply cable 34 can be minimized in length. Further, the extension portion 45 is positioned such that it is not necessary to provide a protrusion for receiving the extension portion 45 to the head housing 61. Therefore, for a worker, a cutting work is not disturbed and a good workability is obtained.

### Second Embodiment

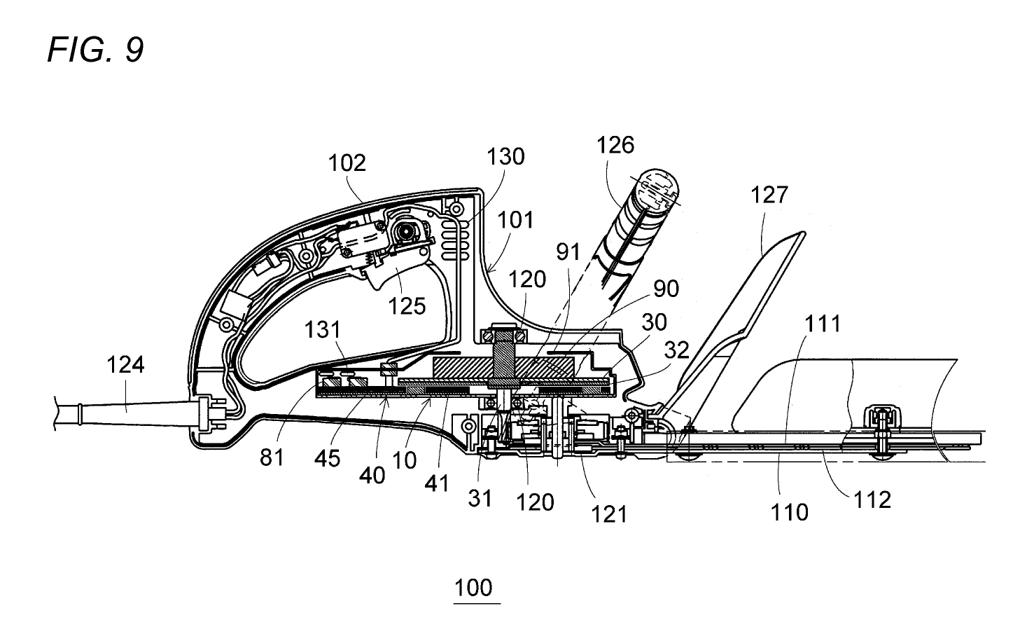

FIG. 9 shows a side sectional view of an electric pruning machine 100 according to a second embodiment of the present invention. The electric pruning machine 100 includes a housing 101, a handle section 102 integrally formed with the housing 101, a brushless disk motor 10 provided at a lower location within inside the housing 101, a blade holder 110 fixed on a bottom surface of the housing, and two blades 111 and 112 reciprocally movably held on the blade holder 110.

The disk motor 10 is identical to that of the first embodiment in that an extension portion 45 of a coil board 41 is also included. In the second embodiment, an output shaft 31 of the disk motor 10 is rotatably supported by a bearing 120 that is fixed inside the housing 101. Rotation of the output shaft 31 is transmitted to two blades 111 and 112 serving as a working unit via a transmission mechanism 121 for converting the rotation motion into a reciprocating motion, so that cutting edges the two blades 111 and 112 can be reciprocally opened and closed, thereby performing trimming of hedges, plants and the like.

A switch 125 is attached to the handle section 102 gripped by a worker. The switch 125 is configured to turn on or off a connection between a power supply cord 124, which is inserted into the housing 101, and the disk motor 10. Also, an auxiliary handle 126 is fixed on a lateral side of the housing. In addition, a safety cover 127 is attached on a side of the housing 101 in which the blades are provided.

In order to cool switching elements 81 and the like mounted on the extension portion 45 of the coil board 41, using a fan airflow by a centrifugal fan 90 integrated with the output shaft 31, an intake hole 130 is formed in an upper portion of the housing 101 and an vent hole 131 is formed inside a fan guide 91 and in a lower portion of the housing 101.

In the electric pruning machine 100 according to the second embodiment as described above, when an electric power is supplied to coil patterns of the coil board 41 as a stator coil through a path of from the power supply cord 124 via the switch 125 to an inverter circuit of a motor driving circuit, rotation of a rotor 30 of the disk motor 10 is started and then the centrifugal fan 90 integrated with the rotor is also rotated to generate a fan airflow. The fan airflow flows from the intake hole 130 via an upper opening of the fan guide 91 (e.g., an opening formed around the output shaft 31) into the centrifugal fan 90 and is discharged form the vent hole 131. By blowing this fan airflow to switching elements 81 of the inverter circuit and the like, the elements can be effectively cooled. Also, the fan airflow can also cool the permanent magnet 32 of the rotor 30.

The second embodiment can also obtain the same effects as those of the first embodiment. For example, the extension portion 45 is provided toward the handle 102 having the switch 124 as viewed from the output shaft 31, the external shape of the disk motor 10 is not protruded from lateral sides or a front side of the electric pruning machine 100. Therefore, it is possible to prevent an operability during a pruning work from being disturbed. Such a fact common to the first and second embodiments can be applied in the same manner to hand-held working machines having other type handles, in which a housing of a disk motor is provided with a working unit, and accordingly the effects as described above can be achieved. In addition, there is an advantage that the same disk motor 10 as that of the first embodiment and the mechanisms associated therewith can be used for the electric pruning machine 100 as it is.

### Third Embodiment

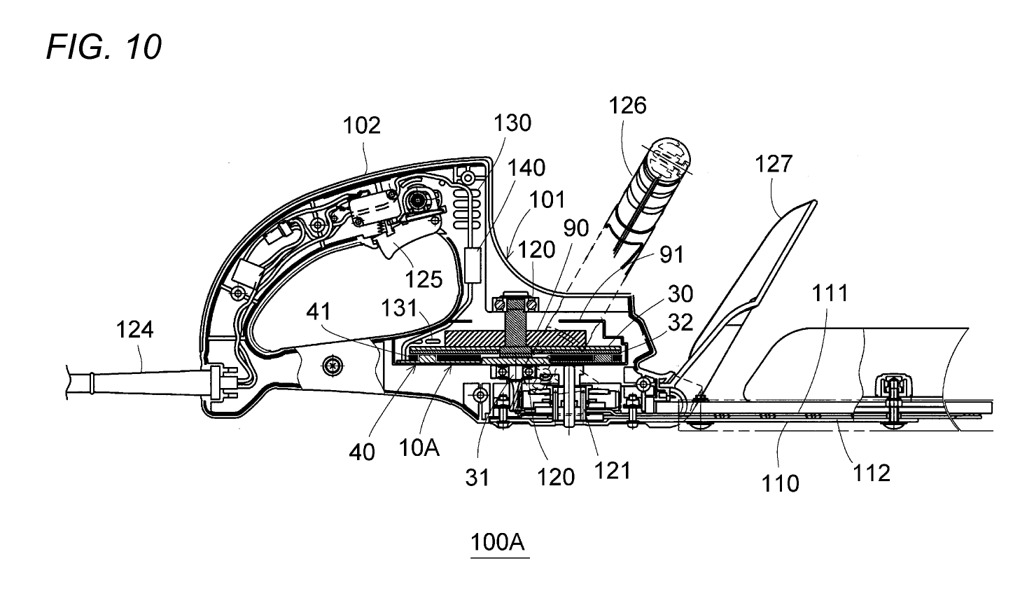

FIG. 10 shows a side sectional view of an electric pruning machine 100A according to a third embodiment of the present invention. In this case, a disk motor 10A does not have an extension portion provided to a coil board 41, and accordingly a motor driving circuit (an inverter circuit or a control circuit) is provided as a separate circuit board 140 in a passage for a fan airflow generated by a centrifugal fan 90. Namely, the circuit board 140 is provided in a air flow passage of from the intake hole 130 via an upper opening of the fan guide 91 (e.g., an opening formed around the output shaft 31) into the centrifugal fan 90. Other configurations are the same as those of the second embodiment.

In the third embodiment, the circuit board 140, on which the motor driving circuit is mounted, can be also effectively cooled by the fan airflow. The disk motor 10A and the circuit board 140 on which the motor driving circuit is mounted are separated from each other, thereby downsizing the disk motor 10A.

In the foregoing, although the present invention was described with respect to the embodiments as examples, it will be understood by those skilled in the art that each component or process of the embodiments can be variously modified within the scope defined by the claims.

Although examples applied to the electric bush cutter 1 or the electric pruning machines 100 and 100A was described in the foregoing embodiments, the present invention is not limited to them, if electric working machines have a disk motor equipped therein. For example, the invention may be also applied to electric power tools, such as a blower, a belt sander, or a rotary band saw, in which a disk motor is equipped.

This application claims the benefit of Japanese Patent Application No. 2012-078778 filed on Mar. 30, 2012, the disclosure of which is incorporated herein in its entirety by reference.

### INDUSTRIAL APPLICABILITY

As described above, an electric working machine according to the invention has advantages of improving energy efficiency. The invention is useful for the electric working machine, for example.

### REFERENCE SINGS LIST

1 Bush cutter

3 Power supply unit

4 Pipe section

5, 102 Handle section

6 Driving unit

7 Cutting blade

10, 10A Motor

30 Rotor

31 Output shaft

32 Permanent magnet

33 Flange

34 Power supply cable

40 Stator

41 Coil board

42 Annular yoke

43 Magnetic core

45 Extension portion

51 Arm

52 Grip

53 Throttle

61 Head housing

62 Cover portion

63 Base portion

65, 120 Bearing

70 Central bore

71 Perforation part

72 Coil pattern

80 Hall sensor

81 Switching element

82 Electronic circuit element

90 Centrifugal fan

91 Fan guide

95, 131 Vent hole

100, 100A Electric pruning machine

101 Housing

102 Handle section

110 Blade holder

111, 112 Blade

121 Transmission mechanism

130 Intake hole

140 Circuit board

1. An electric working machine comprising:
a housing having a motor;
a working unit provided to the housing and is configured to be driven by the motor; and
a gripping section provided to be extended from the housing,
characterized in that:
the motor is a disk motor, the disk motor comprising:
a rotor having a substantially circular disk shape and comprising a plurality of permanent magnet poles;
an output shaft coaxially fixed to the rotor and serving as a rotation center of the rotor; and
a stator having a coil board and generating a magnetic field with respect to the rotor; and
an electric circuit element for a motor driving circuit is mounted on the housing at a side of the gripping section.

2. The electric working machine according to claim 1, wherein:
the coil board comprises an extension portion extending toward the gripping section on an outer circumferential edge thereof; and
the electric circuit element is provided on the extension portion.

3. The electric working machine according to claim 2, wherein:
the gripping section comprises a pipe section attached on the housing; and
the extension portion is provided beneath of the pipe section.

4. The electric working machine according to claim 1, further comprising:
a fan configured to be rotatably driven by a driving force of the rotor;
wherein the fan is configured to generate air flow by being rotated so as to cool the electric circuit element for the motor driving circuit.

5. The electric working machine according to claim 4, wherein the air flow generated by the fan flows along an axial direction of the rotor and then flows toward the gripping section provided in a radial direction.

6. The electric working machine according to claim 5, wherein:
the housing comprises a fan guide, which is configured to cover an outer circumference of an upper surface of the motor, and which has an intake hole formed at the center thereof; and
the air flow is configured to be aspirated from the center of the motor along the fan guide.

7. The electric working machine according to claim 1, wherein:
the coil board has a plurality of through-holes and is configured to generate a magnetic flux extending through each of the plurality of through-holes; and
the stator comprises the coil board, a yoke and magnetic cores integrally formed with the yoke, the magnetic cores being configured to protrude into the through-holes.

8. The electric working machine according to claim 7, wherein the coil board has a conductor coil pattern encircled around each of the through-holes.

9. An electric working machine comprising:
a disk motor comprising:
a rotor having a substantially circular disk shape and comprising a plurality of permanent magnet poles;
an output shaft coaxially fixed to the rotor and serving as a rotation center of the rotor; and
a stator configured to generate a magnetic field with respect to the rotor;
a housing configured to accommodate the rotor and to rotatably support the output shaft;
a fan configured to be rotatably driven by the disk motor; and
a circuit board having an electric circuit element for a motor driving circuit mounted thereon;
wherein the fan is configured to generate air flow by being rotates so as to cool the electric circuit elements for the motor driving circuit.

10. The electric working machine according to claim 9, wherein the circuit board is provided on a flow path of the air flow of the fan inside the housing.

11. The electric working machine according to claim 9, wherein the fan is integrally provided to the output shaft.
